(19) United States
(12) Patent Application Publication
(10) Pub. No.: US 2008/0077524 A1
(43) Pub. Date: Mar. 27, 2008

(54) GLOBAL COMMUNICATION AND TRANSACTION SYSTEM AND METHOD

(76) Inventor: Jeffrey Marc GREENE, Woodbury, NY (US)

Correspondence Address: KATTEN MUCHIN ROSENMAN LLP, 575 MADISON AVENUE, NEW YORK, NY, 10022-2585, US

(21) Appl. No.: 11/859,962

(22) Filed: Sep. 24, 2007

Related U.S. Application Data
(60) Provisional application No. 60/846,876, filed on Sep. 25, 2006.
(60) Provisional application No. 60/851,848, filed on Oct. 16, 2006.
(60) Provisional application No. 60/860,970, filed on Nov. 27, 2006.

(51) Int. Cl. G06Q 20/00; G06F 17/30; G06Q 30/00

(52) U.S. Cl. 705/40; 705/1; 705/39

(57) ABSTRACT

A digital connectivity system including a plurality of digital connectivity providers, each enabling the transfer of digital content over at least one of a plurality of communication pipes, a connectivity consolidator having acquired digital connectivity for a plurality of users from the plurality of connectivity providers enabling access to digital content by the users via each of the plurality of communication pipes, and a digital content device connectable to any of said plurality of pipes. Each of the plurality of users, having contracted with the connectivity consolidator, access the digital content provided over any of the plurality of pipes for which connectivity has been purchased by the connectivity consolidator.

### CROSS REFERENCE TO RELATED APPLICATION

This application claims the benefit of U.S. Provisional Application No. 60/846,876 filed on Sep. 25, 2006, U.S. Provisional Application No. 60/851,848 filed on Oct. 16, 2006 and U.S. Provisional Application No. 60/860,970 filed on Nov. 27, 2006, the entire contents of all three provisional applications are incorporated herein by reference.

### FIELD OF THE INVENTION

The present invention relates to a method and system enabling a user with a user operated digital device to automatically select and switch between digital connectivity pipes, allowing access to desired content based on specified parameters, and enabling constant connection of a user to the desired content.

### BACKGROUND OF THE INVENTION

With the advances in telecommunications, consumers through out the world require digital connectivity. Digital connectivity has become as required by consumers as air, water, and food. Consumers use digital connectivity to receive digital content used in everything from their PC's, phones, TVs, mp3 players, game players, health and security monitors and many more devices. And consumers are increasingly demanding that they have the most efficient or appropriate connectivity for all of their various devices wherever they or their device should happen to be.

Currently the global connectivity market represents a three trillion dollar a year market. Connectivity, originally provided by copper wire now comes through a variety of networks or “Pipes” including such new technologies as Wi-Max, Wi-Fi, EVDO, 3G, 4G, and many more. As new technologies come on-line, they typically overlap with existing connectivity networks and the result is a global glut of connectivity and excess capacity. This excess capacity and the commoditized nature of connectivity has forced many networks to add additional features that are not part of their primary purpose of providing connectivity. For example, many cell phone carriers now provide their own branded content in an effort to maintain customer loyalty, but most connectivity providers run a poor second in terms of developing content as compared to dedicated content providers. Regardless, despite the glut of connectivity and advances in device technology, an individual user's ability to receive content via the new and existing pipes has not been greatly impacted. Other than generally cramming more functions into new devices, each requiring more bandwidth, the advances in technology and the development of new connectivity pipes has not created greater access to more connectivity, that is, greater access to more pipes. Thus many consumers are left with receiving insufficient or sometimes a surplus of connectivity, neither of which is efficient for the consumer.

Compounding the frustration from not being able to get the right connectivity is the process in which customers or users establish access to the connectivity in order to receive content. Currently consumers are left with making individual selections to determine who their connectivity providers and/or content providers will be. This can be a very complicated process for the consumer since choices and options change daily and resulting in much frustration. As shown in FIG. 1, first a consumer must decide what type of functionality and technology they need. Then they have to find the right device which now positions them to begin to select the right network to support their device and their desired functionality.

This selection of carriers is further complicated by the range of connectivity options provided by the carrier and tied to specific types of content. Even once these questions are finalized, the consumer still must determine which pricing and service usage plan provided by the selected connectivity provider is best for them. Questions in this inquiry often include whether there are hidden fees for a particular plan, how long a particular plan must be locked into—one year, two years three years, etc., and finally the question of “what is all this going to cost me?” All of these inquiries must be resolved in order for the consumer to access the desired content or sets of content through a single connectivity provider. Often each of these inquiries must be made for each type of content the consumer or user wants to utilize and/or each device which the consumer wants to receive content on. The frustration felt by the consumers results in the many consumers having little actual control over their connectivity needs and being recipients of too much, too little or the wrong connectivity; all of which lead to overpaying and may result in receiving connectivity and content they neither want, need, nor utilize.

FIG. 2 shows a detailed view of the current connectivity system. In this system, as it exists today, the consumer must make the above-described decisions for connectivity providers for each of his or her digital devices.

For each device there are a number of connectivity provider options, for example, for cellular phones one can choose from Sprint, T-Mobile, Verizon, AT&T, and others. But each one of these companies have different coverage areas, and do not allow for devices other than those pre-approved and/or supplied by the connectivity provider to operate in the system of a second company, and even when they do, they require payment of roaming fees, which can be very expensive. As discussed above, signing up with any one of these connectivity providers means agreeing to the contract terms of that connectivity provider and doesn't guarantee connectivity. Each connectivity provider has a set of unique radio frequency bands, and does not intend for their devices to work in other connectivity providers' frequency bands. This lack of interoperability will often cause dead spots, for one particular carrier while other networks maybe fully operational. Indeed, in a somewhat perverse marketing twist, cellular phone companies often boast about having the fewest dropped or lost calls, but no one can guarantee no dropped calls or connectivity in every location.

Another issue with current cellular phone companies, is that with few exceptions, they tend to be limited to one or two transmission types, and if for example a user has a phone set up for the U.S. system, it will typically not work in Europe or Japan, where different transmission protocols are used. Some common transmission protocols include, CDMA, CDMA2000, GSM, GPRS, EVDO, and UMTS for digital communications. Thus global travelers face serious issues in achieving connectivity when abroad.

The same sorts of issues arise when looking at television or video receiving devices. Again the user has choices, but each has consequences and limitations. The consequences generally relate to how the content is provided to the user, and in some cases by selecting a type of connectivity the user is left with only one provider. For example, if a user decides to choose a cable company, typically in the U.S. there is only one cable company (connectivity provider) in any given area, and they have an exclusive right in that area. If the user decides to choose a satellite receiver, for television and video reception, this too comes at a price in that there are some programs or channels that may not be available from the satellite provider, incidentally the issue occurs with cable providers who are limited in the content they provide to the content providers to whom they have themselves contracted.

A third primary area where users select connectivity providers is in the area of computers and internet connectivity. The three typical choices in the U.S. market are cable modems, again through the local cable company, a digital subscriber line, which may be through a local telephone company or another provider, dial-up connections and a modem, as were much more common 5 years ago, and finally, finding greater market, particularly for its portability and ease of nearly everywhere access is wireless broadband which can come in a variety of forms including Wi-Fi, Wi-Max, 4G, etc., and these are currently offered through a cellular phone companies.

Emerging areas of growth requiring connectivity include items like digital game players, with users either playing a game interactively with other players in other locations, or simply accessing a game without having the entire game software residing on the user's device. Yet further emerging areas of growth for connectivity are health and security monitors. It is predicted that as baby-boomer's age and technology advances, this area will be an explosive area of digital connectivity growth providing care providers with vital signs, and providing a user with the ability to summon assistance, or have the device automatically summon assistance in the event of an accident.

Further as connectivity technology develops and central data processing power and storage costs fall precipitously, more and more functionality and content is stored remotely. This requires digital devices to make a solid appropriate connection with the central system in order to complete a growing number of applications and functionalities.

As a result of all this, an “efficient” user could have four or five separate contracts with connectivity providers. Each of these contracts has a separate bill, separate terms of service, and little or no interconnection. Some companies already recognize the difficulty this causes the user, and as a result cable companies have begun packaging and marketing combined voice, data, and television service under one bill. However, at best this is only a partial solution. First there is currently no provision for connectivity with cellular phones. Second, the combined service is limited to local areas having cable access and cable providers willing to provide all these services. Third, the voice system provided is VoIP and it is often the subject of transmission difficulties leading to both local overloading of IP infrastructure and poor voice quality.

Currently there are a growing number of digital content devices (hereinafter DCDs) capable of working on one, or a couple, but not all of various connectivity provider frequencies and protocols. That is, while a device may work in wireless broadband it may not have the capabilities to alternatively work via a cable connection, without necessitating the services of a separate service provider. More importantly, however, current devices do not have the capability to work with every connectivity provider's protocol that is they cannot access content from every available pipe. The most common example of this is in the area of cellular phones where for example, CDMA phones, common to the U.S. have no connectivity capability with a GSM system such as that used in Europe. Thus a typical U.S. customer must purchase or rent a cellular phone when traveling in Europe, or purchase at extra cost a GSM enabled phone. But the deficiencies of current phones sold in the U.S. are not technological deficiencies, but rather a market deficiency.

As technology has advanced new DCDs are being produced that are capable of receiving and playing, at the same level of efficiency, all types of digital connectivity. That is, it is technologically feasible for every pipe to provide information to the DCD. However under the current service provider/content provider contract system, to be effective, a user would need to have a relationship and at least one DCD with each of the available suppliers of connectivity and then make a decision as to which to use for each attempted connection. This is both inefficient and impractical as most individuals do not wish to pay multiple times for similar service and they do not have sufficient information to make the “right decision” regarding connectivity.

The present invention is directed to resolve these issues of connectivity and to enable a user to have access to all content from all possible connectivity providers and further to create a device capable of selecting the proper connectivity supplier for a given action undertaken by the device in conjunction with parameters set forth by the users. As a result the DCD can select between one of a variety of different pipes and automatically select the best one based on a set of user parameters.

### SUMMARY OF THE INVENTION

One aspect of the present invention is directed to a digital connectivity system encompassing a plurality of digital connectivity providers, each enabling the transfer of digital content over at least one of a plurality of communication pipes, a connectivity consolidator having purchased digital connectivity for a plurality of users from the plurality of connectivity providers enabling access to digital content by the users via each of the plurality of communication pipes, and a digital content device connectable to any of said plurality of pipes. Each of the plurality of users, having contracted with the connectivity consolidator, access the digital content provided over the appropriate one of the plurality of pipes for which connectivity has been purchased by the connectivity consolidator.

These and other aspects of the present invention will be discussed in detail below with reference to the following figures.

### BRIEF DESCRIPTION OF THE FIGURES

FIG. 1 is a flow chart depicting the current issues facing a user seeking connectivity;

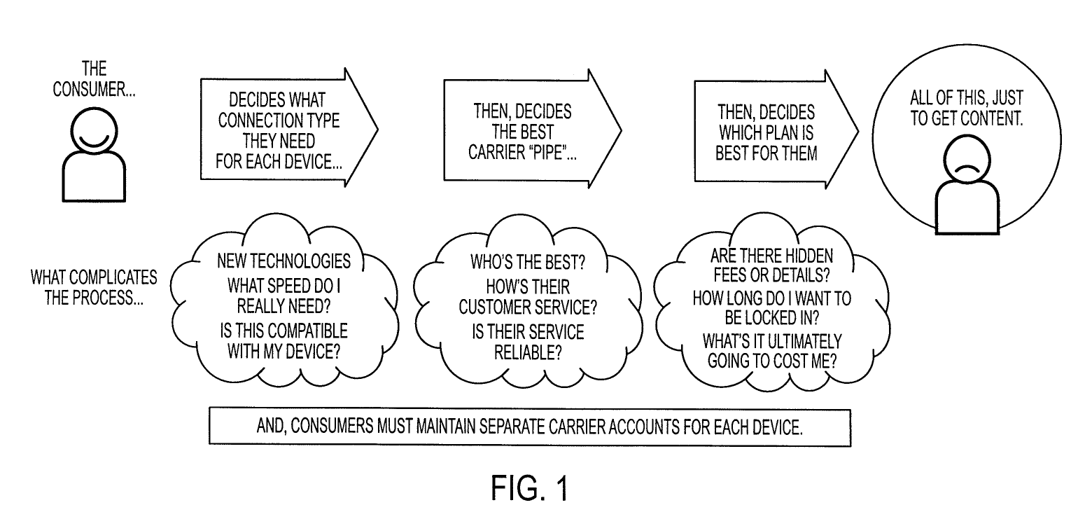

FIG. 2 is a schematic view of the wide variety of connectivity options available through a variety of systems to reach a specified set of content providers;

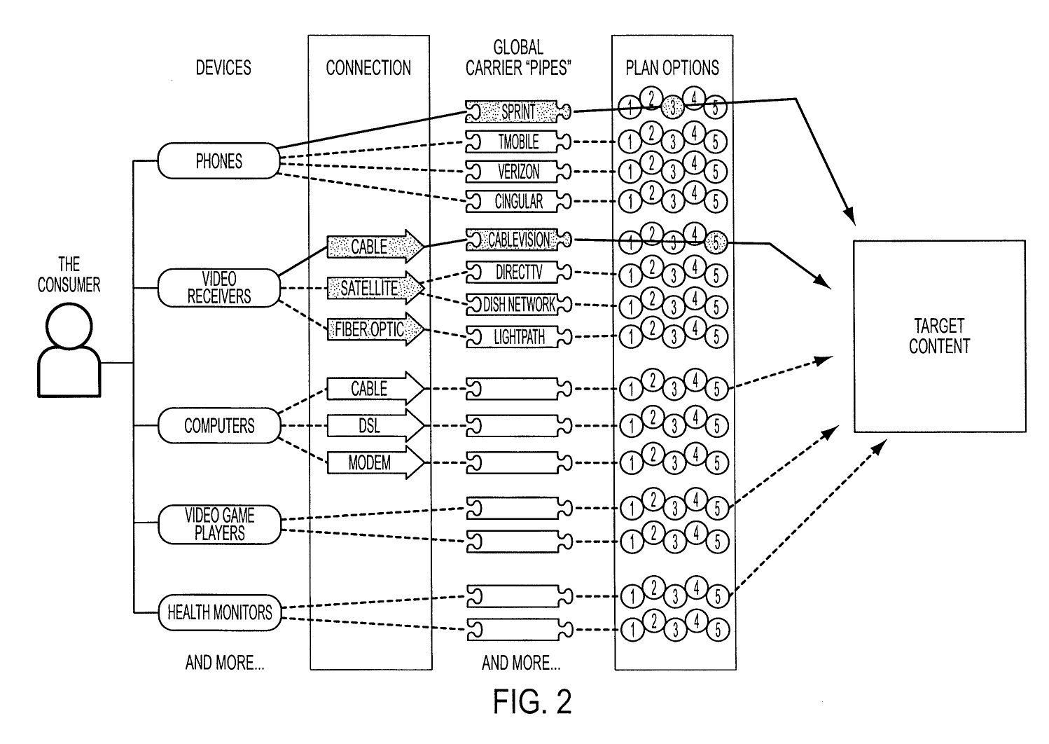

FIG. 3 is a flow chart depicting the connectivity path for a user according to one aspect of the present invention;

FIG. 4 is a view of a DCD and docking station according to one aspect of the present invention;

FIG. 5 is a schematic view of a system incorporating a DCD and SPS according to one aspect of the present invention;

FIG. 6 is a schematic view of a currency and billing system according to one aspect of the present invention;

FIG. 7 is a schematic view of a technology provisioning system according to one aspect of the present invention;

FIG. 8 is a schematic view of connectivity according to one aspect of the present invention;

FIG. 9 is a schematic showing the contractual paths to the content consolidator according to one aspect of the present invention;

FIG. 10 is a flow chart depicting the programming of a SPS for an individual user.

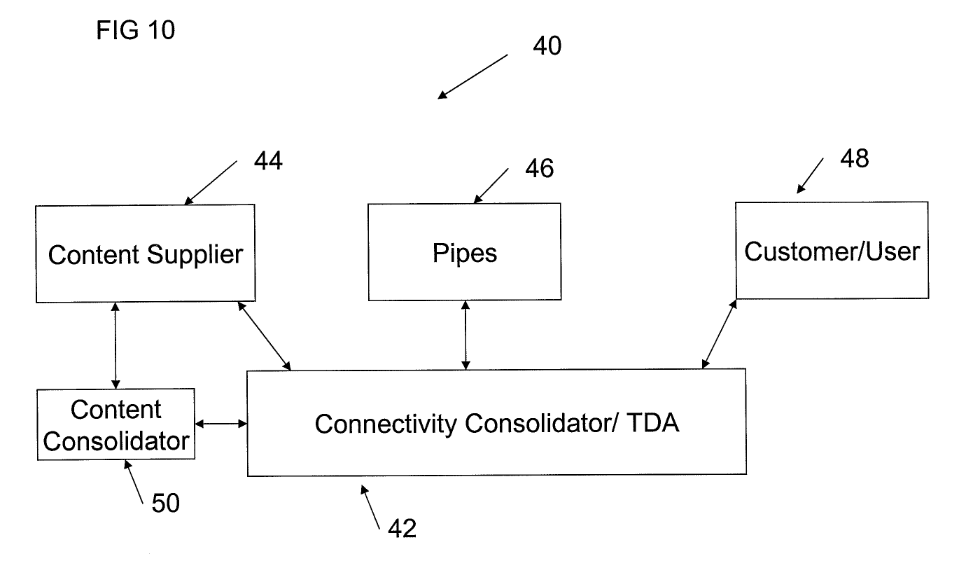

### DETAILED DESCRIPTION

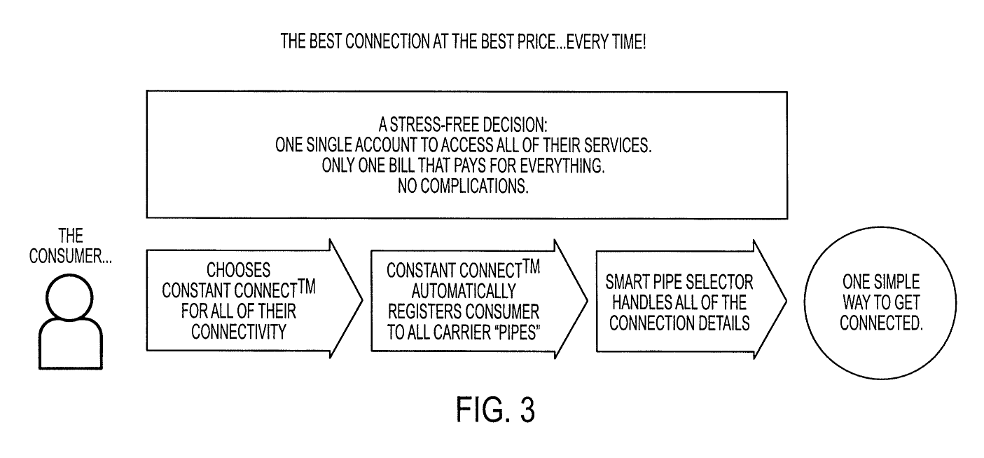

FIG. 3 shows a flow chart of a user achieving proper connectivity in a simplified system. In FIG. 3, the consumer utilizes a system and method that acts as a connectivity consolidator. The connectivity consolidator has pre-purchased bulk connectivity with many connectivity providers for access to their pipes. This enables the user to transmit and receive communications and send or receive content through any of these service providers' pipes. Depending upon the actions the user intends to take, the content the user is looking to view or connect to, and the user's selected use criteria, the connectivity consolidator enables the appropriate connectivity and access to the desired content. This is accomplished by the user being a customer of the connectivity consolidator, and not a customer of any individual service provider. The connectivity consolidator reviews all new technologies and constructs bulk purchase arrangements with any pipe that offers competitive service and adds this connectivity to its existing connectivity portfolio.

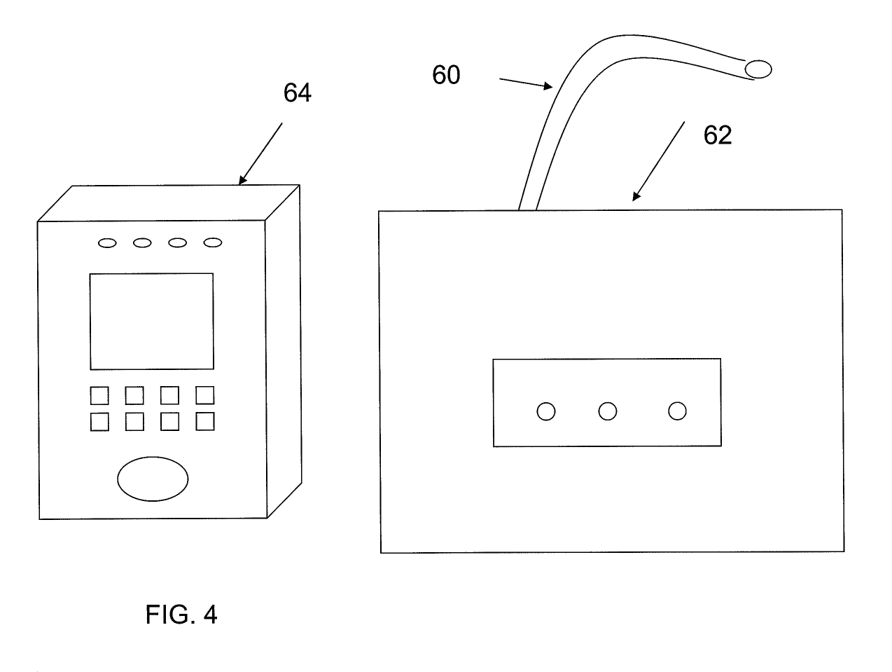

Enabling the system shown in FIG. 3 requires DCDs that are indifferent as to the pipe supplying the connectivity. This technology already exists, however, such devices are only a small portion of the market and are not generally optimized, such that they can appropriately select and receive GSM and CDMA signals, but also satellite communications, as well as Wi-Fi and Wi-Max, and others. This does not necessarily mean that every cell phone need have capabilities to connect directly to a fiber-optic cable for receipt of content, but as devices become more and more hybridized, such a device is not only possible, but may be desirable for some users. In one foreseeable embodiment, as shown in FIG. 4, the connection to fiber 60 is via a docking station 62 to assist in individual tasks, such as satellite and cable television connections in the home, through a DCD 64 that also enables portable wireless communications. The DCD is inserted into the docking station 62 and connected thereto via contacts 66 that connect with similar contacts formed on the DCD 64 for transfer of data to and from the DCD 64 via the docking station 62. Alternatively, the connectivity demands of other devices such as video recorders can be similarly optimized to enable satellite and cable communications, as well as Wi-Fi and Wi-max and others.

The DCDs are indifferent with respect to the communication technology, both the pipes and the protocols used to deliver and transmit digital content. That is, all of the applications of the device will operate in exactly the same manner independent of the pipe that provides connectivity. Currently content is transmitted and received in “n” number of frequencies, bandwidths, formats and protocols, which continually change based on technological advances, capital investment and frequencies available in the market. Thus, the DCD's include the ability to be configured and reconfigured (provisioned) to accommodate the changes in technology of the communication pipes.

The DCDs must match the needs of the users and handle the digital content stream supplied via the various pipes. All the while efficiently facilitating the selection of the most appropriate pipe to match the user's requirements as reflected in a user's profile that drives the SPS.

Pipes include technologies such as fiber optic cable, copper wire, satellite, cell networks (4G+), Wi-Fi, WiMax, electric utility lines, etc. Pipes deliver the content from a content source according to their infrastructure design. Pipes enable connectivity between a content supplier's product and a user and/or and facilitate the interaction with other users matching the specifications of the users' DCDs.

Pipe selection is driven at least in part by the parameters set by the user. These parameters may include things such as a minimum cost per connectivity, strength of connectivity, loyalty rewards, and content exclusivity provisions. Each DCD will have its own Smart Pipe Selector (SPS). The parameters are then matched against the capabilities and pricing of each of the pipes available in a given area and a selection is made by the SPS to connect the user with the content they desire via the SPS selected pipe. For example, if a person is in a remote area and is seeking to make an emergency phone call where price is not a concern, but connectivity is, the DCD in connection with the SPS and the parameter set by the user could choose satellite communication to ensure that the call will be transmitted, and will forego seeking to connect using alternative technology which might provide less security of its connection though it is cheaper and falls within the user's other previously specified parameters.

It is preferred that content providers supply almost all of their digital content via all relevant pipes to all possible users. Naturally there may be some exclusive content limited to a specific pipe or specific user or user group, or differences in the types of pipes available in any area.

The SPS makes its decision as to which of the available pipes to select based on a variety of criteria. First making a determination of the available pipes in a certain area, as noted before these pipes can include (but are not limited to) CDMA, GSM, Wi-Fi, Wi-Max, Bluetooth, Satellite, 3G, 4G, Cable-LAN, fiber optics, and others. The SPS is smart enough to choose from among the pipes based on the preferences set by the user. Factors for selection include, cost per connectivity unit (minutes or KB transferred or other), strength and speed of connection so as to maximize the function, and benefit to the user. Benefit may include access to the exclusive content or accumulation of loyalty points or any other component that is relevant to the user. The signal strength from each of these pipes may be determined at the time of the request for connectivity by the user. These parameters are included in the algorithm applied by the SPS to determine which pipe to use. Other elements of the algorithm include historical signal dependability based on monitoring of the frequency of dropped signals or historical signal strength in a particular area. When considering the digital transfer rate of the network, this may be verified by the connectivity consolidator, and compared with the digital transfer rate necessary for the desired content/user application. Another portion of the algorithm may include determination of optimal signal protocol for the content/application, and/or determination of whether there are any unique requirements of the content or the location of the device. Also taken into consideration are specific device requirements to enable access to the desired content. All of these criteria are included in the algorithm along with the user specifications to determine which pipe best fits all of the criteria to enable access to the content.

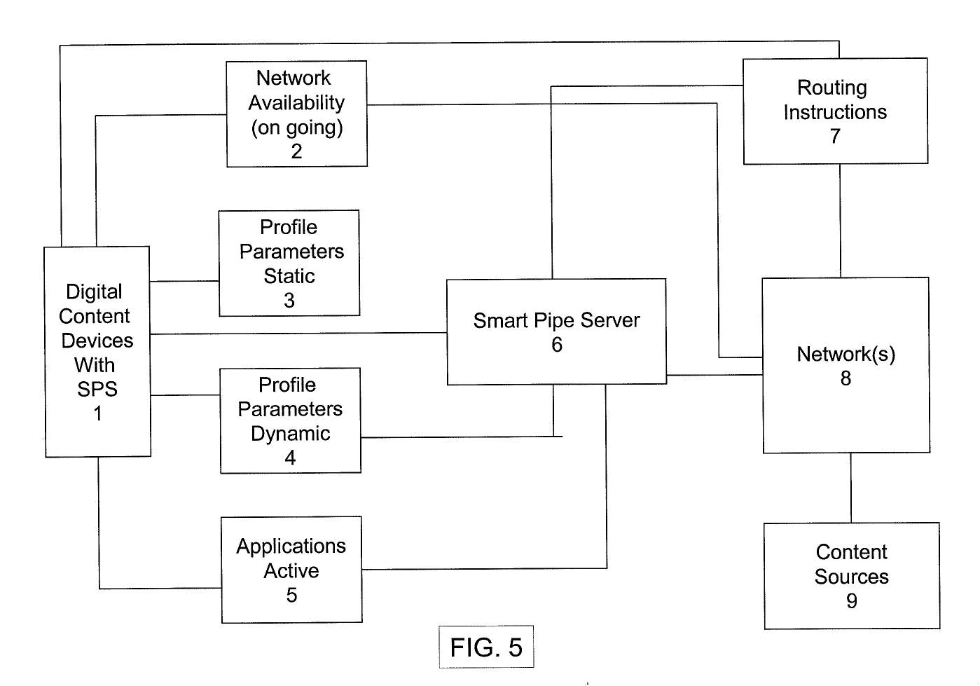

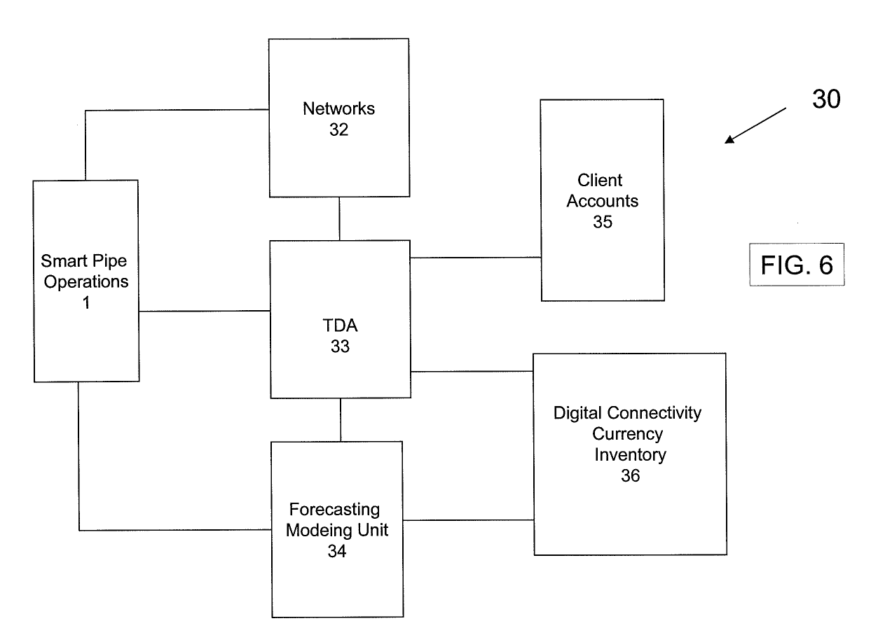

FIG. 5 shows an SPS as part of a DCD 1 located in a system according to one aspect of the present invention. In FIG. 6, the DCD 1 in combination with the SPS utilizes a weighted and adjustable algorithm to determine selection and routing instructions for digital connectivity. Components of the system include a network availability determining unit 2 which conducts continual monitoring of the networks that are contracted to provided services to the DCD to determine what networks are available to the DCD. Another component of the system is a unit 3 storing static profile parameters of the client. These static parameters include the preferences for use as set by the user. As described herein the user set parameters may include things such as price, required strength of signal, preferred networks, availability of rewards points, and others. The static profile unit also stores all of the encrypted and security elements for each client including among others, identification numbers/passwords appropriate for predetermined content sources such as banks, credit card processors etc. These parameters are used by the algorithm to assist in determining the network or pipe to use to receive desired content. Another feature of the system is a dynamic profiling unit 4 performing dynamic profiling of client parameters. The dynamic profiling unit 4 also contains the ever changing elements of the system, that learn and adjust based on the frequency of a clients usage of specific capabilities of the DCD. Further the system includes an applications unit 5, which monitors the applications in use at any one time by the user and makes determinations to open new applications or close existing applications based on user inputs and desired content.

The DCD and SPS 1 interact with the SPS server 6 that provides access to Voice Mail, Email, IM, SMS, MMS, Browser, secure encrypted transaction capability, search power, music/video/TV player power. The SPS server 6 also contains all of the infrastructure functionalities required by the client/user that are more efficiently stored and maintained in the client account within the server as opposed to the DCD. Further, the server will maintain a full backup copy of all of the contents within the DCD.

As shown in FIG. 5, a routing instructions unit 7 carries out the determinations made by the DCD and SPS 1 either alone or in combination with the SPS server 6, and specifically the algorithm, along with input from both the static and dynamic profile units 3 and 4 to route the a request for content to a proper network and return the content to the user using a proper network connection.

The networks 8 are all the connectivity pipes that have been contracted to supply services to the DCD 1. And the content sources 9 are all those end points that contain the “information” to meet the clients needs. These content sources 9 are reached by the most efficient route selected by the SPS using the algorithm and the system described above.

The SPS is truly a smart selector having capabilities to discern requests from the user and direct the request properly to obtain the desired content through the best available pipe.

For example, if the SPS is presented, via the DCD, with a phone number, the SPS connects the user to the most efficient connection to support a voice transmission at the best price. But because the DCD is enabled to not only provide voice connection but a wide variety of connections the SPS must be much smarter than simple price selection for a phone call. If the SPS is presented with a URL request, the SPS must connect the DCD to the most efficient connection to support a data transmission appropriate for the application/content at the best price. Naturally accessing the type of application to be performed via the connection requires greater deterministic abilities of the SPS, than merely determining the lowest cost, it requires a determination of potential necessary bandwidth for the connection. Where the DCD activates a specific application, either locally based on the DCD or web-based via a URL, the SPS must determine the most efficient connection to support a data transmission appropriate for the application, as well as determine the best price among other determinants.

In many instances, a user will not know the appropriate connection requirement. That is, they don't have an input to the DCD which easily identifies the type of pipe needed for receiving the desired content. Take, for example, an instance where a user needs to search for some desired content such as restaurants in an area or music or movies. Inputting the search term such as “restaurant” or “movie” in the DCD will direct the SPS to connect to a search engine incorporated into the connectivity consolidator, and provide the user with a variety of choices based for example on the location of the DCD at the time of request or other criteria input by the user. Once these choices are considered by the user, a selection can then be made, and for example a URL may be retrieved as discussed above, or a phone connection made, either of which the SPS will direct through a proper pipe, using the algorithm discussed above.

Another aspect of the SPS is the ability to prioritize applications based on the history established by each user on all the user's DCD's based upon the previous uses. This feature enables creation of single button accessible categories—such as daily functions, weekly functions, rarely used applications, etc.

Based on the history and identity of the user, which along with the selected preferences of the user make up the user profile, and with the permission of the user, the SPS can deliver user information as part of the connection to content or a pipe. As an example, when connecting to a content supplier for which the client has an existing account the SPS will deliver all of the information necessary for the client to have the most efficient transaction. This means that the “right” level of service can be delivered to the client without client intervention. The SPS can also insert appropriate visual and audio signals at each connection to identify participating entities.

The SPS facilitates the most efficient connection between the DCD, the pipes, and the content/application servers. In some instances, the SPS capability may actually be located in two components, one within the DCD and one housed on an SPS server, which is remotely accessed by the DCD for some processing functions, or accessing information stored at an SPS server, as shown in FIG. 4. However, the SPS may also be located and reside solely on the DCD 1 or solely as an intermediary device between the DCD 1 and the Network(s) 8.

The SPS may be software based, or a combination of hardware and software dependent upon the DCD and may include profiling applications. The SPS is preferably active in all of a user's devices, and is always on once one or more of the devices are powered up. The SPS monitors all applications operating on the DCD. The SPS determines the most efficient connection via the pipes to desired content. Where appropriate, as determined by the SPS software within the DCD, a connection may be routed through a connectivity consolidator server in order to process and add supplemental data to improve the efficiency of the transaction. Each time a connection is established with a designated content source the SPS's profiling software is updated.

Another feature of the present invention is the ability to “hand-off” between pipes such that a call originated in Wi-Fi may be handed to a traditional cellular system and back again or any other pipe without loss of connectivity, as the DCD travels to different locations. This ability is routed through the SPS, which makes the determination to hand off based on all of the user's parameters. The data may be pushed by the content supplier, or pulled by the user or available on an interactive basis reflecting both pushing and pulling.

To enable the SPS to select the preferred pipe for a given action given the parameters of the user, the connectivity consolidator must purchase digital connectivity and access to the pipes in bulk at volume rate prices based on a negotiated unit of measure for re-supply to connectivity consolidator's customers.

Another element of the system is a Telecommunications Disintermediation Agent (TDA) that may work alone or in combination with the connectivity consolidator and utilize the infrastructure and utility components of an existing credit card processing network to process connectivity units (“CU's”) in a manner similar to the treatment of foreign currency.

In one embodiment, it is the TDA that negotiates bulk rate contracts from pipes for negotiated units of service in all relevant markets to meet the needs of their consumer base. The TDA will negotiate bulk purchase contracts of connectivity with all relevant connectivity providers that will be made available to all of the TDA's users. The TDA treats the pipes/connectivity suppliers as merchants allowing them to electronically report to the TDA transaction use of the TDA's customers in negotiated units of measure, CUs.

FIG. 6 shows an exemplary billing and currency system 30 utilizing CUs. The system 30 includes an SPS 1 connected to a TDA 33 that has contracted for connectivity capacity with all relevant pipes or networks 32 in all relevant markets under a variety of terms and conditions that will ultimately create “connectivity currency” the CU's that can be used, traded, or sold by the networks, content providers, TDA and client/user of the DCD.

The networks 32 include all of the pipes under contract to provide connectivity capacity. The networks 32 report transaction details that occur for all DCD's contracted by the TDA 33 and provisioned to operate on the networks 32. One preferred method of reporting the transactions includes the use of EIN's or unique identifiers, established for each DCD and used as a sort of serial number. In one embodiment the networks 32 under contract may be selected by the TDA based on the results of the forecasting models performed by a forecasting modeling unit 34.

The TDA 33 receives details of the connectivity that has been used by the client/user during any billing period. The TDA 33 reconciles with each network 32 and then bills the appropriate clients/user within the parameters and currency of the plan selected by the clients.

A Forecasting modeling unit 34 stores and prepares forecasting models based on detailed data assembled by the TDA 33, detailed data from the SPS 1 and the contractual terms established with each pipe or network 32. The forecast models project the amount of connectivity capacity to be “acquired” for use by the user/client on the DCD. The client/user has credit and debit based client accounts 35 established by each client user of SPS 1 with the TDA 33, and each user is then periodically billed for the CUs used by the client during a set period.

The digital connectivity inventory 36 refers to the amount of digital capacity available under contract with pipes or acquired from other entities that can be used by clients or “sold” in the open market to other users of digital connectivity.

In general, the TDA reconciles with the connectivity suppliers and pays them in compliance with negotiated terms. In one embodiment, the connectivity suppliers electronically, and in real time, supply usage data to the TDA based on the negotiated unit of measure for all content delivered to the TDA's users. The TDA receives the charges in CUs from the connectivity suppliers in a similar fashion to receiving transaction charges in any foreign currency and the TDA operates with the connectivity supplier in a manner similar to a standard merchant in a credit/debit card relationship.

The TDA receives charges in CUs from the connectivity suppliers and converts those charges at predetermined rates for posting debits to each user account. The TDA may establish connectivity unit credit within a users account and charges each user according to predetermined rates. The TDA converts that charge, in CU's at predetermined rates for posting CU debits to each user client in the billing currency of the user. Optionally, the TDA can establish CU credit scores to be added to their existing user accounts.

Thus, customers are consumers of CU's from all possible pipes and content suppliers but are billed only once, from the TDA. Thus the customer ceases to consume minutes from a cell phone company and programming from a cable company, and gaming time from a gaming company, but rather consumes the CU's for all of their content or media needs. The consumer's use is based both on the devices for which they wish to receive connectivity and the profile parameters that they have established which could include, for example, cost per connectivity, strength of connectivity, loyalty rewards, content exclusivity provisions etc. These CU's can be consumed by the customer whenever they utilize their phones, TV's, video players, audio players, data/test devices, monitoring devices etc., any device that can receive and or send digital content. Users can purchase their total CU needs through a TDA as opposed to opening an account with all possible connectivity suppliers. The final transaction/payment to the TDA can be a credit based account or prepaid account that will reflect the predetermined pricing program selected by the user. The TDA's established account relationship with the user, similar to a credit card (or prepaid account) that facilitates the posting of converted CU charges, like a foreign exchange transaction into the billing rate and currency of the user. The TDA bills in the selected currency of the user, in accordance with the usage based contract established by the user all of the connectivity units used by the user during the billing period. The TDA supplies all of the customer services in support of the user consistent with and similar to a credit/debit card account.

The TDA provides, consumer/user credit, purchasing power, account maintenance, reconciliation, customer services and merchant (pipe) accounting in a manner very similar to credit card operations. All transactions and the accounting thereof are electronic thereby allowing for a very low transaction costs and solid margins.

In one embodiment, each consumer/user is recognized on each pipe as a user within the TDA's master account at that pipe. In turn the TDA will be billed at the TDA's negotiated rates for all use by any of the accounts identified as a part of the TDA buying group. As such the TDA becomes the responsible party for payment to the pipes. Each user will have an identifier that uniquely identifies them and the bulk contract under which they will access and use services from pipes and/or content suppliers.

The TDA supports the user in developing the most appropriate algorithm to drive the SPS that yields the maximum utility for the user at the lowest price. The TDA works with all of the relevant manufacturers to insure that the available DCDs can comply with the user needs for an SPS and create appropriate files reflecting the amount of use which can be used to facilitate customer reconciliation via the TDA to the billings from the content suppliers and pipes.

Another aspect of the invention deals with the content suppliers. Though much content is free including broadcast television and radio transmissions, and other content such as voice transmission for telephone calls requires only accessing the pipes, increasingly content is being charged for by the content suppliers. In some instances, the content suppliers may be the same parties as the connectivity suppliers, but generally this is not the case. Some connectivity providers such as cable companies and satellite television companies have existing contracts to supply exclusive content over their pipes. Thus in one embodiment of the present invention, the connectivity consolidator or TDA may include in their bulk connectivity purchase, access to all content provided through the respective connectivity providers. This may include the option for a user to select content that requires additional surcharges, such as pay-per-view movies, and have such content supplied to the user via an appropriate pipe. However, in another embodiment, it may be desirable to establish a content consolidator which contracts with content providers to make their content available to customers of the content consolidator. This option may be incorporated into the connectivity contract with the connectivity supplier requiring the connectivity supplier to provide one or more pipes for transmission of the content to the user, even though the connectivity provider has not itself contracted with the content provider. Still another embodiment enables user to pay for only that content which they actually request and receive. This is a pure content pull system where the user is in command of the content it receives.

Yet a further aspect of the present invention is the Technology Provisioning Agent (TPA) which builds, in cooperation with all relevant OEMs, a global detailed and continually refreshed (approaching real time) database of all relevant DCDs and their specifications and programmable options. The specification may include a methodology to register each user and their “buyer” profile designation with each pipe. The TPA works with all of the relevant manufacturers to insure that the DCDs comply with the user needs for an SPS and create appropriate files reflecting the amount of use that can ultimately be used to facilitate customer reconciliation via the TDA to the billings from the content sources and pipes.

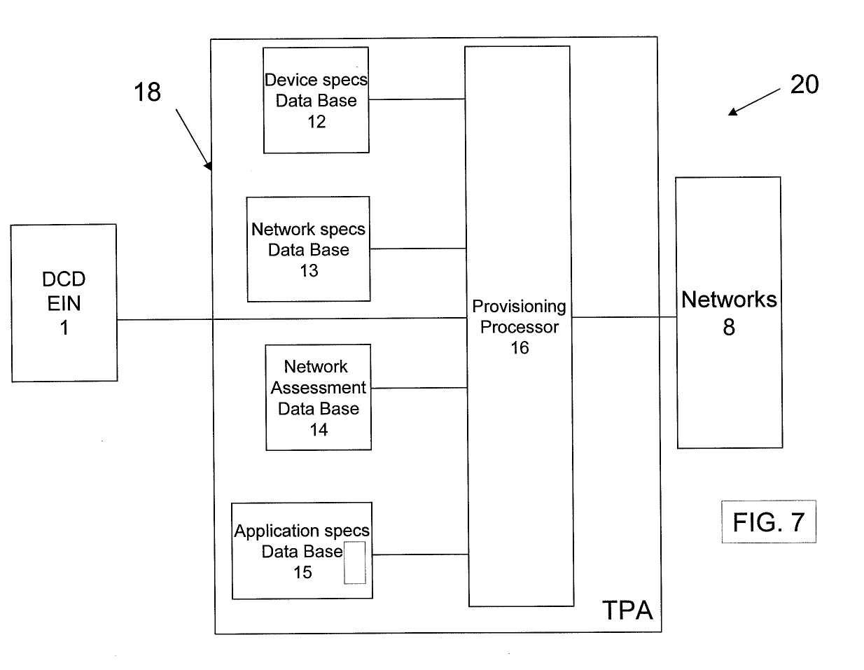

FIG. 7 shows an example of a TPA 18 in a system 20 connected to a DCD 1 and the networks or pipes 8. The DCD in FIG. 6 includes a Unique Identifier Number (EIN) which acts as a serial number for the DCD and is recognized by the TPA for management and provisioning of the DCD to ensure the DCD maintains the necessary capabilities to operate on the networks 8.

The TPA 18 includes a device specifications database 12 containing detailed and continually updated information regarding the capabilities and requirements of all recognized OEMs devices (DCD's) capable of performing the functionality required by the client user. The TPA also includes a network specifications database 13 containing detailed and continually updated information regarding the capabilities and requirements of all of the contracted networks (pipes). Yet another portion of the TPA is a network assessment database 14 containing performance measures of each pipe including, among other factors, strength of signal, dependability (up time and dropped call or signal factors), geographic foot print, etc. The TPA 18 also includes an application specifications database containing the requirements of each application and processing capability on the clients' DCD.

The provisioning processor 16, based on the data retrieved from elements 12-1, determines the networks that have the capability to meet the clients' needs and then registers the clients EIN with those networks. The TPA also updates the DCDs and specifically the SPS and SPS server such that the DCD's are capable of connecting to all of the networks or pipes 8 that are contracted to provide connectivity to the DCDs.

Consumers/users of DCDs utilize an interactive profile builder to develop the key parameters to drive their unique SPS selection process including: DCDs they own, geographic coverage they need/expect, functions that they want to perform with their DCDs and the level of service/functionality they expect. The TPA delivers to the consumer/user a “solution” that reflects all the proposed options to meet the users needs including an estimated cost. The solution will also suggest options and adjustments the user can make to match service to their needs including options at a lower price, providing better coverage, or other potentially desirable features. The consumer may also initiate parameter overrides. The TPA, guided by the user, develops a “solution” and provisions the DCD with the solution to give them all the possible connectivity options that could be required to meet the users' needs. The consumer parameters drive the TPAs provisioning program that enables all of the user's DCD's to efficiently communicate through all of the relevant pipes. The user “solution” profile in turn guides the SPS in determining the “right” connection for the user requested function for the DCD.

The consumers' parameters are concurrently loaded into the SPS software that is loaded onto all of a user's provisioned DCDs. A confirmation of successful provisioning is required to complete the activation of the SPS.

The TDA, in partnership with the TPA, create and maintain an all encompassing real time data base of OEM DCD devices, pipes capabilities and pricing for all connectivity options. To this data base using an interactive assessment tool, the users add their requirements, preferences and biases.

Using a series of optimizing programs that may be continually or periodically updated, a set of consumer parameters are generated that drive the TPA's provisioning operation and will make all of the user's DCDs capable of accessing all of their preferred pipes. The TDA will support the user in developing the most appropriate algorithm to drive the SPS that yields the maximum utility for the user at the lowest price.

A further operation of the TPA is the continual review of the process based on the ever changing conditions and service offerings in the global telecommunications market, any changes of significance including adding DCDs will cause an updating of the consumer parameters, provisioning and the Smart Pipe Selector tool. All of these functions are transparent to the user and do not require user participation. However, a user accessible SPS review tool is maintained in real time to assure the consumer of the efficiency of the tool.

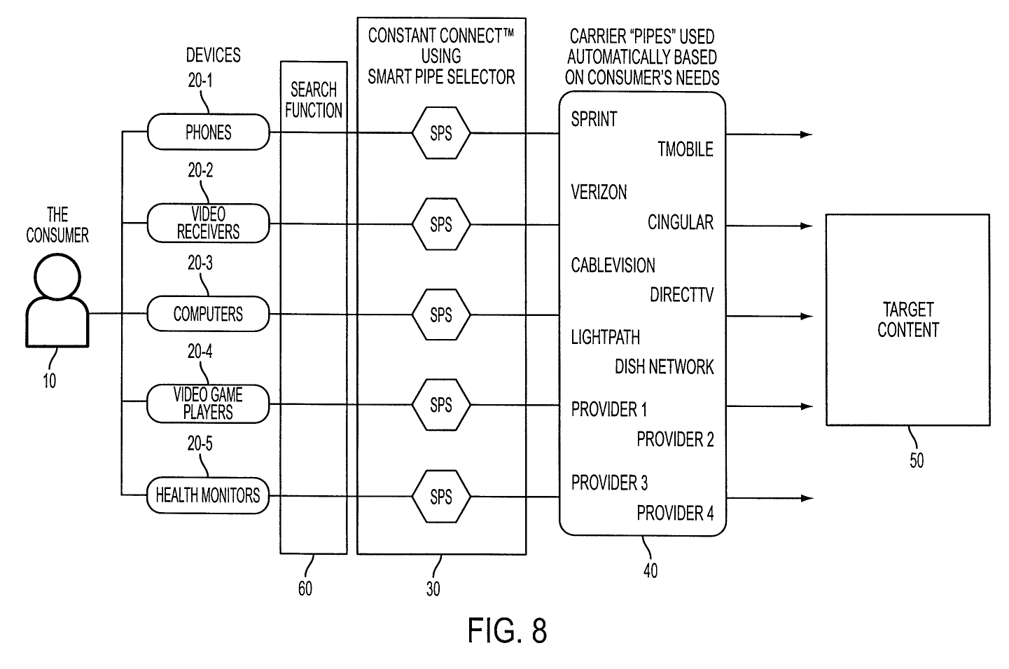

FIG. 8 shows a user's perspective of the system of the present invention in operation. The user 10, selects one of his many DCD's 20-1 through 20-5 which have been registered with a content consolidator or TDA (not shown). If for example, the DCD selected is a cellular phone, the user 10 can then begin to dial a phone number. Given the parameters of the user profile discussed above, which are stored in the SPS 30, the DCD 20-1 in combination with the SPS 30, makes a connection through a particular pipe from the plurality of pipes 40 to connect with the target content 50, in this case another cell phone user.

A similar selection process can made with a video receiver 20-2 as the DCD. In that case, the user 10 selected the video receiver 20-2, and based on the user profile in the SPS 30 the DCD 20-2 is directed to the pipe 40 which best supports the content sought by the user.

In many instances, a user 10 may not know exactly what they are looking for in terms of content. Rather they may have a general idea that requires searching. For televisions, this has previously meant that a user 10 had to scan all available channels, or look to various directories. Included within the DCD's and incorporated with the SPS 30 is a search function 60. This search function has two purposes. First it provides alternatives for a user 10 to select from in making a content selection. Secondly, based on the search parameters, the SPS can seek out the best route for obtaining the content that is likely sought after. Thus, for example, if a user types in HBO into the search function, the SPS 30 can determine with some likelihood that the user 10 intends to view movie programming and will seek to find the best broadband source to receive that content.

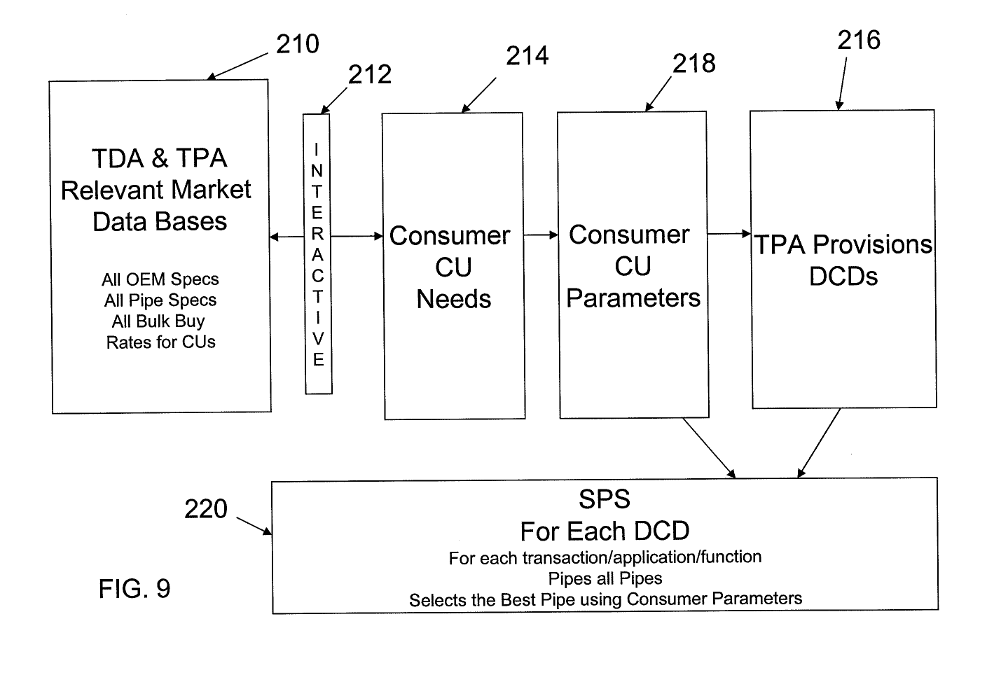

The process flow for establishing the SPS is shown in FIG. 9. As discussed above, the TDA and TPA determine all of the DCD's which are available to users and keeps these DCD's in a database. The databases also include specifications of the various pipes, and information related to the bulk connectivity and/or content purchases. All of this is shown in step 210. The customer interacts, step 212 with the TDA and TPA to establish their need in terms of connectivity 214. For example, an average person may have a cellular phone, a PDA, require internet access, and also require TV programming access. Based on this the customer needs in terms of connectivity can be established, as well as a proposed number of CU's required to meet the connectivity demands at step 214. Given the user's needs, the TPA will provision the user's DCD's with the appropriate algorithms to drive the SPS for the user in step 216. The user, in conjunction with the TPA establishes the user profile 218 to be used in the SPS 220. Following this process the user has a DCD equipped with an SPS for to enable the maximization of connectivity based on the user's parameters.

Another feature of the present invention is the ability for a single device to be a world wide personnel locater. As part of a DCD such as a cellular phone, there may be included a transponder of sorts, which includes GPS location information, that can be broadcast back to the content consolidator/TDA and may be further broadcast to other user's as desired in a user agreement. By this device, employers can track personnel movements, as required by say a company such as UPS. Similarly, parents may track children and their movements, if they are part of the same connectivity plan.

The connectivity consolidator model, as discussed herein, has distinct impacts on each of the content suppliers and pipes. Each will be discussed in some detail below.

With respect to cellular phone usage, consumers no longer are trapped by their plans and contract periods. The user has a single contract with the connectivity consolidator, and purchases or obtains credit for a number of CU's monthly. But these CU's are useable on any system that is within the content consolidator's program. Thus a user may utilize the frequencies of Sprint, Verizon, AT&T, and others without penalties such as roaming charges. Indeed, roaming charges cease to exist in this system. Secondly, the concept of a dropped or lost call should be substantially eliminated. Within the framework of the user profile, the hand-off capabilities between systems and different technologies should allow a call to remain constantly connected.

With respect to video receivers, the user is now given the opportunity to do exactly what a large portion of the population has always wanted, a la carte viewing. Cable companies have resisted it, and though satellite providers are somewhat better, the decision for satellite always includes some drawbacks and loss of local programming. By the system described above, a user is able, possibly using the search function, to select the specific programming they desire, and only pay for that portion which they actually consume. Thus television programming becomes a content pull driven system rather than the content push driven system where a great deal of unwanted content is pushed onto the user and they are forced to pay for it. As part of this, given that so many people continue to channel surf, one portion of the system might enable a channel surf feature, that allows for appropriate viewing time at little or minimal charge, and only charges the full amount for some content when a substantial portion of the programming is viewed. Or a preview system as found in current pay-per-view systems may be employed.

For internet access, the user is again free of a single provider, and has all the options available in any area in which they may be. As Wi-Fi, wireless broadband, Wi-MAX and others continue to expand, this represents significant connectivity options for users to enjoy. Though for example, many people currently user cable modems in their homes for high-speed access, these are often coupled with wireless routers enabling laptop users to move their computers about in their homes and remain connected. In such a scenario, in addition to the home wireless router access could also be supplied by Wi-Max and other wireless broadband internet connections as directed by the SPS based on the user's profile.

Another feature is that minute based plans cease to exist. Rather all plans with the content consolidator become CU plans, and CU's act as a new form of currency as between the connectivity consolidator, the customer/user, the connectivity suppliers and the pipes, and the content supplier. The monetary/CU relationships discussed above, can be also be seen in FIG. 9, where it shows that the connectivity consolidator 42 is the party with negotiated contracts with the content suppliers 44, the pipes/connectivity providers 46, and the customer/users 48. Thus by the purchase of a certain number of CU's the user utilizes the pipes and has access to the content suppliers who have contracts with the connectivity consolidator or TDA. Though shown in FIG. 5 as including a content consolidator 50, need not be included in the system of the present invention, but would expand the content available to the consumer.

Thus by the foregoing invention, the connectivity issues of current users may be resolved such that connectivity is made possible nearly world wide, without dropped transmissions, and in a consumer friendly, cost effective manner that reduces the stress and frustration experienced in the current system.

We claim:

1. A digital connectivity system comprising:
a plurality of digital connectivity providers, each enabling the transfer of digital content over at least one of a plurality of communication pipes;
a connectivity consolidator, said connectivity consolidator having acquired digital connectivity for a plurality of users from the plurality of connectivity providers enabling access to digital content by the users via each of the plurality of communication pipes; and
a digital content device connectable to any of said plurality of pipes, wherein
each of said plurality of users, having contracted with the connectivity consolidator, access connectivity acquired by the connectivity consolidator.

2. The system of claim 1, further comprising a smart pipe selector, said smart pipe selector determining which of the plurality of pipes to select from the plurality of pipes to enable user access to the digital content.

3. The system of claim 2, wherein the selection of a pipe is based on user criteria.

4. The system of claim 2, wherein the selection of a pipe is based on the type of content to be delivered to the digital content device.

5. The system of claim 1, further comprising a content consolidator, said content consolidator acquiring content from a plurality of content providers, and enabling access to the content by the plurality of users via the plurality of pipes.

6. The system of claim 1, wherein the plurality of connectivity providers include a plurality of mobile and wired phone carriers.

7. The system of claim 1, wherein the plurality of connectivity providers include cable and satellite television digital connectivity providers.

8. The system of claim 1, wherein the plurality of connectivity providers include internet service, Wi-Fi, Wi-Max, and LTE providers.

9. The system of claim 2, wherein the content consolidator is charged by the content providers in connectivity units (CU's).

10. The system of claim 1, wherein the connectivity consolidator is charged by the connectivity providers in connectivity units (CU's).

11. The system of claim 10, wherein the user pre-purchases or establishes a credit for a certain number of CUs, from which debits in the amount of connectivity consumed is made by the connectivity consolidator in payment for use of the contracted connectivity suppliers' pipes.

12. The system of claim 9, wherein the user pre-purchases or establishes a credit for a certain number of CUs, from which debits in the amount of content consumed is made by the content consolidator in payment for content received from the content suppliers.

13. The system of claim 10, wherein the connectivity supplier monitors the number of CUs consumed by the user and bills the connectivity consolidator for the consumption of the user.

14. The system of claim 9, wherein the content providers monitors the number of CUs consumed by the user and bills the content consolidator for the consumption of the user.

15. The system of claim 14, wherein based on a negotiated contract the content consolidator pays the content supplier for the user's consumed CUs.

16. The system of claim 13, wherein based on a negotiated contract the connectivity consolidator pays the connectivity supplier for the user's consumed CUs.

17. A digital content device (DCD) comprising:
means for connecting to a plurality of connectivity pipes;
a user interface, enabling a user to input any of a search query, a telephone number, a URL, and a desired content identifier; and
a smart pipe selector (SPS) for determining the most efficient connectivity pipe to connect the user to the desired content.

18. The digital content device of claim 17, further comprising a search utility for conducting searching of one or more connected databases based on a user entered query.

19. The digital content device of claim 18, wherein results of a search query input by a user are displayed on a display portion of the DCD.

20. The digital content device of claim 19, wherein upon selection of a result from a search, the SPS determines the most efficient connectivity pipe to return the content of the selected search result.

21. The digital content device of claim 20, wherein the SPS determines efficiency based on the parameters of the content requested.

22. The digital content device of claim 20, wherein the SPS determines efficiency based on user parameters entered before the search.

23. The digital content device of claim 20, wherein the SPS determines efficiency based on the historical practices of the user.

24. A smart pipe selector comprising:
means for monitoring the connectivity pipes available to a digital content device (DCD) at the location of the DCD;
means for analyzing a request for a desired content input by a user via the DCD;
means for determining the most efficient connectivity pipe to connect to deliver the desired content; and
means for connecting the DCD to the pipe determined to be most efficient.

25. The smart pipe selector of claim 24, wherein the determination of efficiency is based on user parameters.

26. The smart pipe selector of claim 24, wherein the means for connecting including means for switching from one pipe to another pipe when it is determined that another pipe provides the most efficient connection to the desired content.
